(19) United States
(12) Patent Application Publication
(10) Pub. No.: US 2026/0134850 A1
(43) Pub. Date: May 14, 2026

(54) IMAGE DISPLAY METHOD AND DISPLAY DEVICE

(71) Applicant: HUAWEI TECHNOLOGIES CO., LTD., Shenzhen (CN)

(72) Inventors: Huaqiang Huang, Shenzhen (CN); Pengfei Zhao, Shenzhen (CN); Congbiao Jiang, Shenzhen (CN); Chunlei Guo, Shenzhen (CN)

(73) Assignee: HUAWEI TECHNOLOGIES CO., LTD., Shenzhen (CN)

(21) Appl. No.: 19/441,137

(22) Filed: Jan. 6, 2026

Related U.S. Application Data
(63) Continuation of application No. PCT/CN2024/102502, filed on Jun. 28, 2024.

(30) Foreign Application Priority Data
Jul. 6, 2023 (CN) 202310827948.3

(51) Int. Cl. G09G 5/02; G09G 5/36

(52) U.S. Cl. CPC G09G 5/02; G09G 5/36

(57) ABSTRACT

This application provides an image display method, where the method is applied to a display device. The display device includes an application processor and a display circuit connected to the application processor, the display circuit includes N display chips, each of the N display chips includes a receive interface and an extraction circuit, the receive interfaces of the N display chips are respectively connected to a transmit interface of the application processor, and N is an integer greater than or equal to 2. The method includes: application processor sends a to-be-displayed image to each of the N display chips, the to-be-displayed image includes data of M color channels, and M is an integer greater than or equal to 2; and each of the N display chips receives the to-be-displayed image, and extracts, via the extraction circuit, data of P target color channels from the to-be-displayed image for display, where 1≤P<M.

### CROSS-REFERENCE TO RELATED APPLICATIONS

This application is a continuation of International Application No. PCT/CN2024/102502, filed on Jun. 28, 2024, which claims priority to Chinese Patent Application No. 202310827948.3, filed on Jul. 6, 2023. The disclosures of the aforementioned applications are hereby incorporated by reference in their entireties.

### TECHNICAL FIELD

This application relates to the field of image display technologies, and in particular, to an image display method and a display device.

### BACKGROUND

In the image display field, there is a working scenario in which an upper-level primary device simultaneously drives three lower-level secondary devices. For example, because a single-chip full-color of a micro light-emitting diode (LED) is immature, an upper-level application processor (AP) of current augmented reality (AR) display based on the micro LED needs to split red green blue (RGB) data of an image into data of three channels: an R channel, a G channel, and a B channel, and simultaneously send the data to lower-level display driver chips to implement a three-chip color-combined full-color. Consequently, the upper-level AP needs to perform complex separation, which increases a size and costs of a display device.

Therefore, how to reduce the size and costs of the display device is an urgent technical problem to be resolved.

### SUMMARY

Embodiments of this application provide an image display method and a display device. An application processor in the display device directly sends a to-be-displayed image to each display chip in a display chip module, the display chip extracts, via an extraction circuit, data of a target color channel in the to-be-displayed image for display, and an upper-level AP does not need to perform complex separation on the to-be-displayed image, so that a size and manufacturing costs of the display device can be reduced.

According to a first aspect, an image display method is provided, where the method is applied to a display device. The display device includes an application processor and a display chip module connected to the application processor, where the display chip module includes N display chips, the display chip includes a receive interface and an extraction circuit, the receive interfaces of the N display chips are separately connected to a transmit interface of the application processor, and N is an integer greater than or equal to 2. The method includes: The application processor sends a to-be-displayed image to each of the N display chips, where the to-be-displayed image includes data of M color channels, and M is an integer greater than or equal to 2; and the display chip receives the to-be-displayed image, and extracts, via the extraction circuit, data of P target color channels from the to-be-displayed image for display, where 1≤P<M.

According to the image display method provided in this embodiment of this application, the application processor in the display device directly sends the to-be-displayed image to each display chip in the display chip module, the display chip extracts, via the extraction circuit, the data of the target color channel in the to-be-displayed image for display, and the upper-level AP does not need to perform complex separation on the to-be-displayed image, so that a size and manufacturing costs of the display device can be reduced.

It should be understood that the application processor may be connected to the display chip module through a one-drive-N data cable.

For example, the to-be-displayed image may be an RGB image, a CMYK image, or a Lab image. When the to-be-displayed image is an RGB image, M=3, and the RGB image includes data of three color channels: a red R channel, a green G channel, and a blue B channel. When the to-be-displayed image is a CMYK image, M=4, and the CMYK image includes data of four color channels: a cyan (C) channel, a magenta (M) channel, a yellow (Y) channel, and a black (K) channel. When the to-be-displayed image is a Lab image, M=3, and the Lab image includes data of three color channels: a lightness channel, a red-green degree (a-axis) channel, and a yellow-blue degree (b-axis) channel.

A format of the to-be-displayed image is not limited in this application. For example, when the to-be-displayed image is an RGB image, the RGB image may be in a format like RGB888, RGB666, RGB101010, RGB121212, RGB565, RGB555, RGB444 or RGB332.

With reference to the first aspect, in some implementations of the first aspect, each of the N receive interfaces of the N display chips includes a terminal resistor, and the terminal resistors of the N receive interfaces are connected in parallel.

The receive interface of the display chip may include a receive (RX) channel, and the terminal resistor may be included in the RX channel of the display chip. It should be understood that because the N display chips of the display chip module are separately connected to the transmit interface of the application processor, the terminal resistors of the N receive interfaces of the display chip are connected in parallel.

According to the image display method provided in this embodiment of this application, the application processor in the display device is separately connected to the N display chips, and directly sends the to-be-displayed image to each display chip in the display chip module, the display chip extracts, via the extraction circuit, the data of the target color channel in the to-be-displayed image for display, and the upper-level AP does not need to perform complex separation on the to-be-displayed image, so that a size and manufacturing costs of the display device can be reduced.

With reference to the first aspect, in some implementations of the first aspect, at least a part of the N receive interfaces share a terminal resistor.

It should be understood that a terminal resistor of the display chip module is usually configured to match an output impedance of the transmit interface of the upper-level AP, to ensure maximum power transmission and minimum reflection of a signal. Because the terminal resistors of the receive interfaces of the N display chips in this application are connected in parallel, a resistance value of the terminal resistor in the display chip module decreases. Therefore, in this application, it may be set that at least a part of the N receive interfaces share a terminal resistor, for example, all terminal resistors of a part of the receive interfaces are turned off in a floating manner, to increase the resistance value of the terminal resistor in the display chip module.

According to the image display method provided in this embodiment of this application, at least a part of the N receive interfaces of the N display chips share a terminal resistor, to increase the resistance value of the terminal resistor in the display chip module, ensure that an input impedance of the display chip matches an output impedance of the AP, and improve quality of a transmitted signal.

With reference to the first aspect, in some implementations of the first aspect, the terminal resistor of the receive interface is Q times a terminal resistor of the transmit interface, and 1<Q≤N+1.

It should be understood that a terminal resistor of the display chip module is usually configured to match an output impedance of the transmit interface of the upper-level AP, to ensure maximum power transmission and minimum reflection of a signal. Because the terminal resistors of the receive interfaces of the N display chips in this application are connected in parallel, a resistance value of the terminal resistor in the display chip module decreases. Therefore, to improve the quality of the transmitted signal, a resistance value of the terminal resistor of the receive interface of the display chip may be increased. For example, a resistance value of the terminal resistor in each of the N display chips is increased by Q times, that is, the resistance value of the terminal resistor of the receive interface of each display chip is Q times a resistance value of a terminal resistor of the transmit interface of the upper-level application processor. In a possible implementation, if N=3, resistance values of the terminal resistors in the three display chips may be increased separately by three times, that is, the resistance value of the terminal resistor of the receive interface of each display chip is three times the resistance value of the terminal resistor of the transmit interface of the upper-level application processor. This ensures that an input impedance of the display chip matches an output impedance of the AP, and improves the quality of the transmitted signal.

According to the image display method provided in this embodiment of this application, the resistance value of the terminal resistor of the receive interface of the display chip is Q times the resistance value of the terminal resistor of the transmit interface of the application processor, and 1<Q≤N+1. Therefore, the resistance value of the terminal resistor in the display chip module is increased, and it is ensured that the input impedance of the display chip matches the output impedance of the AP, thereby improving the quality of the transmitted signal.

With reference to the first aspect, in some implementations of the first aspect, the display chip further includes a display unit; and that the display chip receives the to-be-displayed image, and extracts, via the extraction circuit, the data of the P target color channels from the to-be-displayed image for display includes: The receive interface receives the to-be-displayed image, and sends the to-be-displayed image to the extraction circuit; the extraction circuit extracts the data of the P target color channels from the to-be-displayed image; and the display unit displays the data of the P target color channels.

For example, the to-be-displayed image is an image in an RGB888 format, and the receive interface of the display chip receives the to-be-displayed image sent by the application processor, and sends the to-be-displayed image to the extraction circuit. Each pixel of the image in the RGB888 format corresponds to three bytes, that is, 24 bits 0 to 23. In this embodiment of this application, in the 24 bits of each pixel, bits 0 to 7 represent R-channel data, bits 8 to 15 represent G-channel data, and bits 16 to 23 represent B-channel data. The display chip may extract required data of a target color channel, for example, any one or more of the R-channel data, the G-channel data, and the B-channel data, based on configuration information in the extraction circuit, and then control the display unit to display the data of the target color channel.

According to the image display method provided in this embodiment of this application, the application processor in the display device directly sends the to-be-displayed image to each display chip in the display chip module, the display chip extracts, via the extraction circuit, the data of the target color channel in the to-be-displayed image for display, and the upper-level AP does not need to perform complex separation on the to-be-displayed image, so that a size and manufacturing costs of the display device can be reduced.

With reference to the first aspect, in some implementations of the first aspect, the transmit interface and the receive interface are high-speed serial interfaces (HSSIs).

The high-speed serial interface is a serial interface standard. It uses high-speed transmission technologies and protocols to implement high-speed, reliable, and stable data transmission.

For example, the transmit interface and the receive interface may be mobile industry processor interfaces (MIPIs), low-voltage differential signaling (LVDS) interfaces, or the like. Specific types of the transmit interface and the receive interface are not limited in this application.

With reference to the first aspect, in some implementations of the first aspect, the to-be-displayed image includes an RGB image, and the data of the M color channels includes R-channel data, G-channel data, and B-channel data.

According to a second aspect, a display device is provided. The display device includes an application processor and a display chip module connected to the application processor. The display chip module includes N display chips, the display chip includes a receive interface and an extraction circuit, the receive interfaces of the N display chips are separately connected to a transmit interface of the application processor, and N is an integer greater than or equal to 2. The application processor is configured to send a to-be-displayed image to each of the N display chips, where the to-be-displayed image includes data of M color channels, and M is an integer greater than or equal to 2. The display chip is configured to extract, via the extraction circuit, data of P target color channels from the to-be-displayed image for display, where 1≤P<M.

With reference to the second aspect, in some implementations of the second aspect, each of the N receive interfaces of the N display chips includes a terminal resistor, and the terminal resistors of the N receive interfaces are connected in parallel.

With reference to the second aspect, in some implementations of the second aspect, at least a part of the N receive interfaces share a terminal resistor.

With reference to the second aspect, in some implementations of the second aspect, the terminal resistor of the receive interface is Q times a terminal resistor of the transmit interface, and 1<Q≤N+1.

With reference to the second aspect, in some implementations of the second aspect, the receive interface is configured to: receive the to-be-displayed image, and send the to-be-displayed image to the extraction circuit.

With reference to the second aspect, in some implementations of the second aspect, the display chip further includes a display unit, and the display unit is configured to display the data of the P target color channels.

With reference to the second aspect, in some implementations of the second aspect, the transmit interface and the receive interface are high-speed serial interfaces.

With reference to the second aspect, in some implementations of the second aspect, the to-be-displayed image includes an RGB image, and the data of the M color channels includes red R-channel data, green G-channel data, and blue B-channel data.

Beneficial effects of the second aspect and any possible implementation of the second aspect correspond to the beneficial effects of the first aspect and any possible implementation of the first aspect. Details are not described herein again.

According to a third aspect, an electronic device is provided, including a transmission component and the display device according to the second aspect and any possible implementation of the second aspect, where the transmission component is configured to transmit data of a to-be-displayed image to the display device.

### BRIEF DESCRIPTION OF DRAWINGS

FIG. 1 is a diagram of a working scenario in which a primary device drives three secondary devices according to an embodiment of this application;

FIG. 2 is a diagram of splitting RGB image data via an adapter in the conventional technology;

FIG. 3 is an example diagram of a structure of a display device according to an embodiment of this application;

FIG. 4 is an example flowchart of an image display method according to an embodiment of this application;

FIG. 5 is an example flowchart of an image display method according to an embodiment of this application;

FIG. 6 is an example diagram of extracting color channel data of an RGB image according to an embodiment of this application;

FIG. 7 is a diagram of extracting channel data of an image in an RGB888 format according to an embodiment of this application;

FIG. 8 is a diagram of extracting channel data of an image in an RGB666 format according to an embodiment of this application;

FIG. 9 is an example diagram of a structure of a display chip 610 according to an embodiment of this application;

FIG. 10 is an example diagram of extracting color channel data of a CMYK image according to an embodiment of this application; and

FIG. 11 is an example diagram of an electronic device according to an embodiment of this application.

### DESCRIPTION OF EMBODIMENTS

The following describes technical solutions in embodiments of this application with reference to the accompanying drawings. It is clear that the described embodiments are a part rather than all of embodiments of this application. All other embodiments obtained by a person of ordinary skill in the art based on embodiments of this application without creative efforts shall fall within the protection scope of this application.

In embodiments of this application, the word like “example” or “for example” is used to represent giving an example, an illustration, or a description. Any embodiment or design scheme described as an “example” in this application should not be explained as being more preferred or having more advantages than another embodiment or design scheme. Exactly, the word “example” is for presenting a concept in a specific manner.

A service scenario described in embodiments of this application is intended to describe the technical solutions in embodiments of this application more clearly, but does not constitute a limitation on the technical solutions provided in embodiments of this application. A person of ordinary skill in the art may learn that as a new service scenario emerges, the technical solutions provided in embodiments of this application are also applicable to a similar technical problem.

Reference to “one embodiment”, “some embodiments”, or the like described in this specification means that a specific feature, structure, or characteristic described with reference to the embodiment is included in one or more embodiments of this application. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. The terms “include”, “comprise”, “have”, and their variants all mean “including but not limited to”, unless otherwise specifically emphasized in another manner.

In this application, “at least one” means one or more, and “a plurality of” means two or more. “And/Or” describes an association relationship between associated objects, and represents that three relationships may exist. For example, A and/or B may represent the following cases: Only A exists, both A and B exist, and only B exists, where A and B may be singular or plural. A character “/” generally represents an “or” relationship between associated objects. “At least one of the following items (pieces)” or a similar expression thereof refers to any combination of these items, including a single item (piece) or any combination of a plurality of items (pieces). For example, at least one item (piece) of a, b, or c may represent: a, b, c, a and b, a and c, b and c, or a, b, and c, where a, b, and c may be singular or plural.

For ease of understanding of embodiments of this application, some definitions in this application are first briefly described.
1. Augmented reality (AR): A technology in which a virtual world on a screen can be combined and interacted with a real world scenario by performing actuarial calculation on a location and an angle of a camera image and by using an image analysis technology.
2. Color-combined full-color: A display mode that controls RGB semiconductor light-emitting diodes. A full-color LED display includes many RGB-three-color light-emitting diodes. Each pixel combination includes an RGB diode. Full-color pictures of different colors are displayed by turning on or off each group of pixel lights.
3. Impedance matching: That an internal resistance of a signal source and a characteristic impedance of a connected transmission line are the same in magnitude and phase, or a characteristic impedance of a transmission line and an impedance of a connected load are the same in magnitude and phase is referred to as that an input end or output end of the transmission line is in an impedance matching state. Otherwise, it is referred to as impedance mismatching.

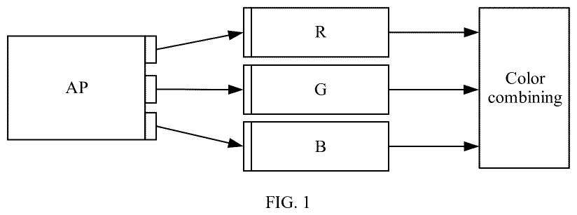

FIG. 1 is a diagram of a working scenario in which a primary device drives three secondary devices according to an embodiment of this application.

In the image display field, there is a working scenario in which an upper-level primary device simultaneously drives three lower-level secondary devices. For example, because a single-chip full-color of a micro LED is immature, an upper-level application processor (AP) of current augmented reality (AR) display based on the micro LED needs to split a red green blue (RGB) image into data of three channels: a red (R) channel, a green (G) channel, and a blue (B) channel, and simultaneously drive the data to lower-level display driver chips to implement a three-chip color-combined full-color. Consequently, the upper-level AP needs to perform complex separation, which increases a size and costs of a display device.

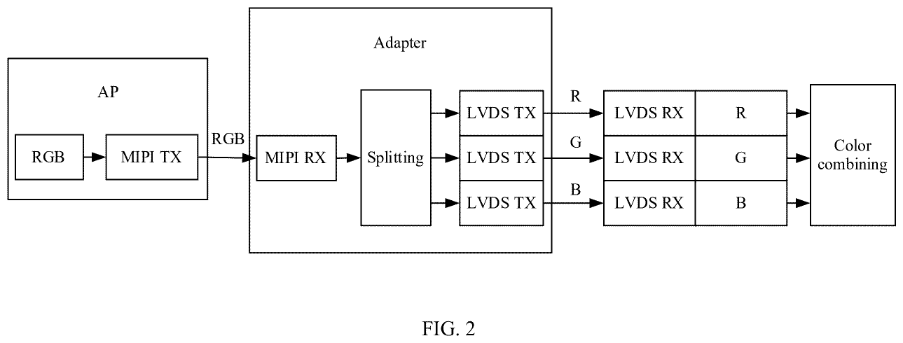

FIG. 2 is a diagram of splitting RGB image data via an adapter in the conventional technology.

As shown in FIG. 2, an upper-level AP sends RGB data to an adapter through a transmit (TX) channel of a mobile industry processor interface (mobile industry processor MIPI). The adapter receives the RGB data through a receive (RX) channel of the MIPI, splits the RGB data into data of R, G, and B channels separately, and then forwards the data of the R, G, and B channels to lower-level display chips through low-voltage differential signaling (LVDS) interfaces. The lower-level display chips receive the data of the three R, G, and B channels through LVDS interfaces and perform color-combined display.

In the conventional technology shown in FIG. 2, the adapter needs to be added to split and forward the data of the three R, G, and B channels, a display device needs to reserve space for the adapter, and there are many board-level traces, resulting in a large size of a board-level interconnection channel. For example, if a format of the RGB image data sent by the AP is an RGB888 format, each bit of the RGB data needs to correspond to one trace, and 24 traces need to be routed at a board level.

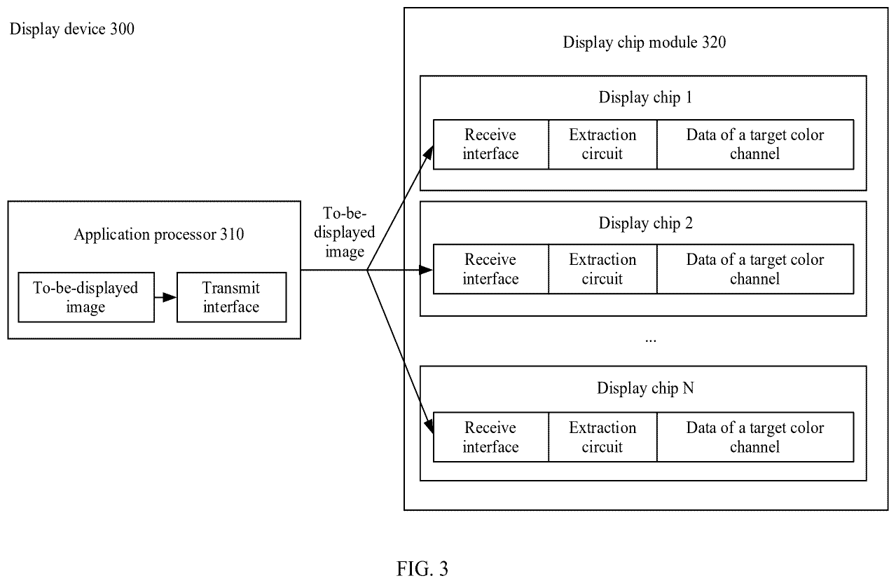

FIG. 3 is an example diagram of a structure of a display device according to an embodiment of this application.

The display device 300 includes an application processor 310 and a display chip module 320 connected to the application processor 310. The display chip module 320 includes N display chips, and N is an integer greater than or equal to 2. Each display chip includes a receive interface and an extraction circuit. The receive interfaces of the N display chips are separately connected to a transmit interface of the application processor. It should be understood that the application processor 310 may be connected to the display chip module 320 through a one-drive-N data cable.

The application processor 310 is configured to send a to-be-displayed image to each of the N display chips, where the to-be-displayed image includes data of M color channels, and M is an integer greater than or equal to 2.

The display chips 1 to N are configured to extract, via the extraction circuits, data of P target color channels from the to-be-displayed image for display, where 1≤P<M.

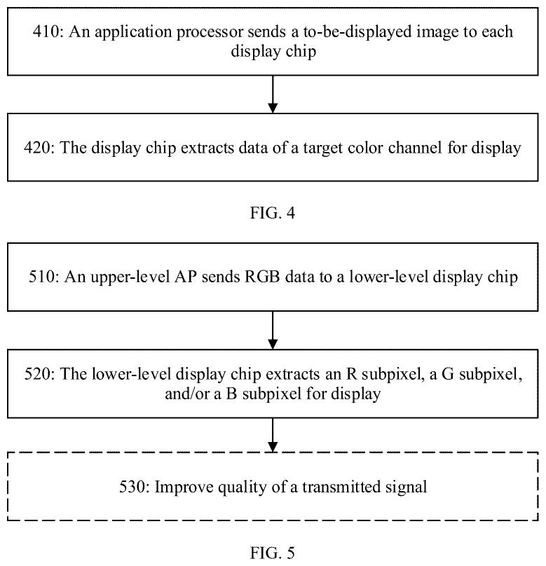

FIG. 4 is an example flowchart of an image display method according to an embodiment of this application. The image display method is applied to the display device 300 shown in FIG. 3.

410: An application processor sends a to-be-displayed image to each display chip.

The application processor 310 sends the to-be-displayed image to each of the N display chips of the display chip module 320, where the to-be-displayed image includes the data of the M color channels, and M is an integer greater than or equal to 2.

For example, the to-be-displayed image may be an RGB image, a CMYK image, or a Lab image. When the to-be-displayed image is an RGB image, M=3, and the RGB image includes data of three color channels: a red R channel, a green G channel, and a blue B channel. When the to-be-displayed image is a CMYK image, M=4, and the CMYK image includes data of four color channels: a cyan (C) channel, a magenta (M) channel, a yellow (Y) channel, and a black (K) channel. When the to-be-displayed image is a Lab image, M=3, and the Lab image includes data of three color channels: a lightness channel, a red-green degree (a-axis) channel, and a yellow-blue degree (b-axis) channel.

A format of the to-be-displayed image is not limited in this application. For example, when the to-be-displayed image is an RGB image, the RGB image may be in a format like RGB888, RGB666, RGB101010, RGB121212, RGB565, RGB555, RGB444 or RGB332.

420: The display chip extracts data of a target color channel for display.

The display chip receives the to-be-displayed image, and extracts, via the extraction circuit, the data of the P target color channels from the to-be-displayed image for display, where 1≤P<M.

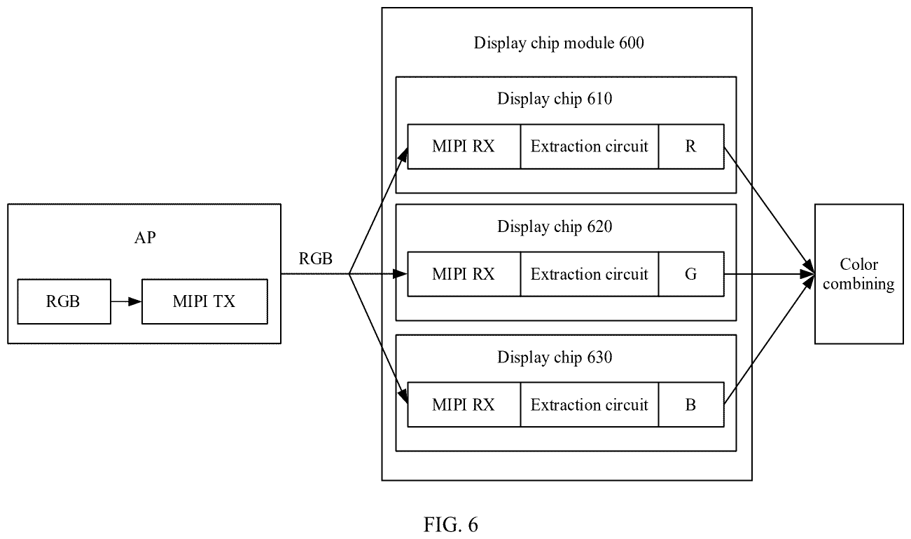

FIG. 5 is an example flowchart of an image display method according to an embodiment of this application. FIG. 6 is an example diagram of extracting color channel data of an RGB image according to an embodiment of this application. FIG. 6 corresponds to FIG. 5.

510: An upper-level AP sends RGB data to a lower-level display chip.

As shown in FIG. 6, an AP obtains RGB data of a to-be-displayed image, and sends the RGB data to a display chip module 600 through a one-drive-three data cable and an MIPI. The display chip module 600 includes three lower-level display chips: a display chip 610, a display chip 620, and a display chip 630.

520: The lower-level display chip extracts data of an R channel, a G channel, and/or a B channel for display.

The RGB data of the to-be-displayed image includes RGB data of each pixel in the image. The lower-level display chip may extract, based on the RGB data of each pixel in the to-be-displayed image, any one or more of R-channel data, G-channel data, and B-channel data that correspond to each pixel.

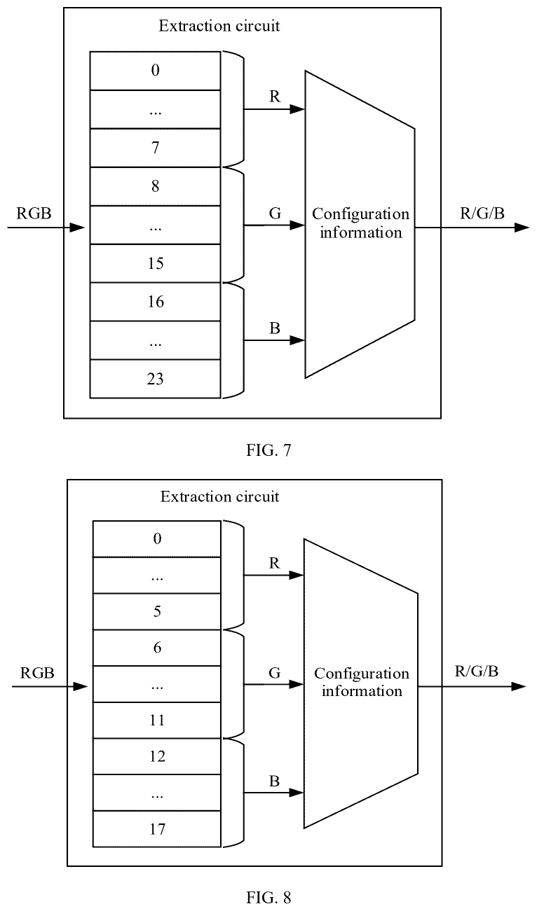

FIG. 7 is a diagram of extracting channel data of an image in an RGB888 format according to an embodiment of this application. As shown in FIG. 7, each pixel of the image in the RGB 888 format corresponds to three bytes, that is, 24 bits 0 to 23. In this embodiment of this application, in the 24 bits of each pixel, bits 0 to 7 represent R-channel data, bits 8 to 15 represent G-channel data, and bits 16 to 23 represent B-channel data. The lower-level display chip may extract required data of a target color channel, for example, any one or more of the R-channel data, the G-channel data, and the B-channel data, based on configuration information in an extraction circuit. It should be understood that, in FIG. 7, that the bits 0 to 7 represent the R-channel data, the bits 8 to 15 represent the G-channel data, and the bits 16 to 23 represent the B-channel data is an example. Color channel data corresponding to the three bytes of each pixel may be set as required. For example, the bits 0 to 7 may represent the B-channel data, the bits 8 to 15 may represent the G-channel data, and the bits 16 to 23 may represent the R-channel data. Specific color channel data represented by different bits should not be understood as a limitation on this application.

FIG. 8 is a diagram of extracting channel data of an image in an RGB666 format according to an embodiment of this application. As shown in FIG. 8, each pixel of the image in the RGB666 format corresponds to 18 bits 0 to 17. In this embodiment of this application, in the 18 bits of each pixel, bits 0 to 5 are set to represent R-channel data, bits 6 to 11 are set to represent G-channel data, and bits 12 to 17 are set to represent B-channel data. The lower-level display chip may extract required data of a target color channel, for example, any one or more of the R-channel data, the G-channel data, and the B-channel data, based on configuration information in an extraction circuit. It should be understood that, in FIG. 8, that the bits 0 to 5 represent the R-channel data, the bits 6 to 11 represent the G-channel data, and the bits 12 to 17 represent the B-channel data is an example. Alternatively, the bits 0 to 5 may represent the G-channel data, the bits 6 to 11 may represent the B-channel data, and the bits 12 to 17 may represent the R-channel data. Specific color channel data represented by different bits should not be understood as a limitation on this application.

Similarly, different color channel data may also be extracted from images in formats such as RGB101010, RGB121212, RGB565, RGB555, RGB444 and RGB332 in manners shown in FIG. 7 and FIG. 8. A format of the to-be-displayed image is not limited in this application.

Optionally, one display chip may alternatively be used to extract data of a plurality of color channels. For example, the display chip module 600 includes the display chip 610 and the display chip 620. The display chip 610 may be configured to extract the data of the R channel and the data of the G channel, and the display chip 620 may be configured to extract the data of the B channel. The display chip module includes a plurality of display chips. A quantity of display chips included in the display chip module 600 shown in FIG. 6 should not be construed as a limitation on this application.

530: Improve quality of a transmitted signal.

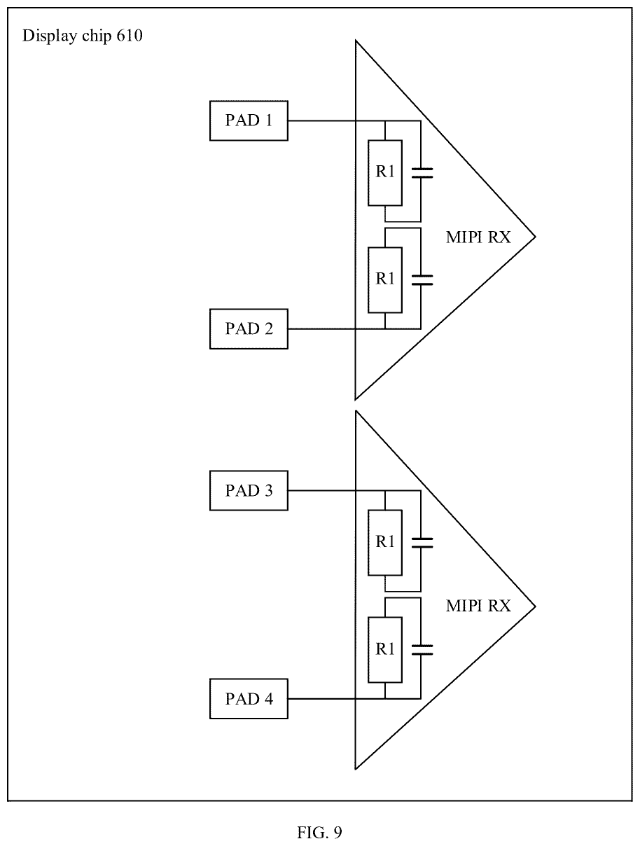

FIG. 9 is an example diagram of a structure of a display chip 610 according to an embodiment of this application. Structures of the display chip 620 and the display chip 630 are the same as that of the display chip 610. The display chip 610 includes a group of clock signal lines and a group of data signal lines, and each group of clock signal lines and data signal lines includes two lines, that is, the display chip 610 includes four traces. A PAD 1 to a PAD 4 on the display chip 610 are pin interfaces around the chip, and are configured to: connect to an external circuit, and transmit a clock signal or a data signal. For example, the PAD 1 and the PAD 2 may be connected to two data signal lines to transmit a data signal, and the PAD 3 and the PAD 4 may be connected to two clock signal lines to transmit a clock signal.

Each of the display chip 610, the display chip 620, and the display chip 630 includes a receive interface, for example, an MIPI. Each receive interface includes an RX channel, and the RX channel includes at least one terminal resistor R1. It should be understood that the terminal resistor of the receive interface of the display chip is usually configured to match an output impedance of the transmit interface of the upper-level AP, to ensure maximum power transmission and minimum reflection of a signal. Selection of the terminal resistor may affect performance and stability of the display chip. If the resistor is incorrectly selected, signal distortion, reflection, and interference may be caused, thereby affecting display quality and system performance.

As shown in FIG. 6, because the terminal resistors of the three display chips 610 to 630 are connected in parallel in this embodiment of this application, a resistance value of the terminal resistor in the display chip module 600 decreases. Therefore, to improve the quality of the transmitted signal, a resistance value of the terminal resistor of the receive interface of the display chip may be increased. For example, a resistance value of the terminal resistor of the MIPI RX channel in each of the display chips 610 to 630 is increased by Q times, in other words, the resistance value of the terminal resistor of the RX channel of each display chip is Q times a resistance value of a terminal resistor of a TX channel of a transmit interface of the upper-level application processor, where 1≤Q≤N+1, N is a quantity of display chips included in the display chip module, and N is an integer greater than or equal to 2. In a possible implementation, because the three display chips 610 to 630 are connected in parallel in this embodiment of this application, resistance values of the terminal resistors of the receive interfaces of the display chips 610 to 630 may be increased separately by three times, in other words, a resistance value of a terminal resistor of an RX channel of a receive interface of each display chip is three times a resistance value of a terminal resistor of a TX channel of the transmit interface of the upper-level application processor. This ensures that an input impedance of the display chip matches an output impedance of the AP, and improves the quality of the transmitted signal.

Optionally, terminal resistors of RX channels of a part of the display chips 610 to 630 may be disconnected, that is, a selected terminal resistor is suspended, to increase the resistance value of the terminal resistor in the display chip module. For example, all terminal resistors of the RX channels of the display chip 610 and the display chip 620 may be turned off in a floating manner, that is, the three display chips 610 to 630 share the terminal resistor of the display chip 630, to increase the resistance value of the terminal resistor in the display chip module, ensure that an input impedance of the display chip matches an output impedance of the AP, and improve the quality of the transmitted signal.

For the RGB image, according to the image display method provided in this embodiment of this application, an adapter does not need to be additionally used to split the RGB data, and the RGB data may be directly sent to the lower-level display chip in a one-drive-three mode for display. In addition, only 12 traces of a board level are required for the three display chips, so that a size of an interconnection channel in a display device can be reduced.

It should be understood that, in this embodiment of this application, data transmission through the MIPI is merely an example, or a high-speed serial interface like an LVDS may be used. This figure should not be understood as a limitation on this application.

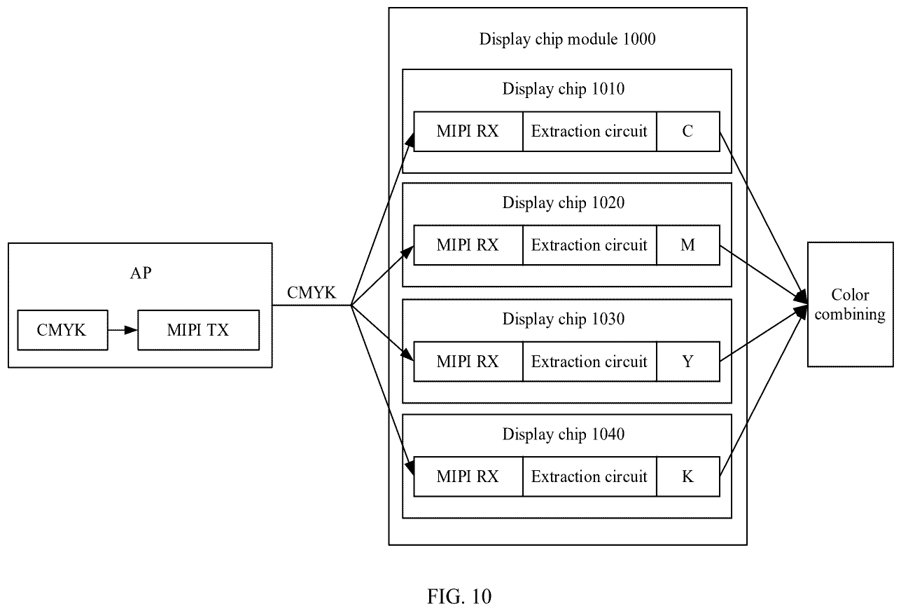

In some possible application scenarios, in this embodiment of this application, color channel data of a CMYK image may also be extracted. The CMYK image includes four color channels: a cyan (C) channel, a magenta (M) channel, a yellow (Y) channel, and a black (K) channel. FIG. 10 is an example diagram of extracting color channel data of a CMYK image according to an embodiment of this application. As shown in FIG. 10, an AP obtains CMYK data, and sends the CMYK data to a display chip module 1000 through a one-drive-four data cable and by using an MIPI. The display chip module 1000 includes four lower-level display chips: a display chip 1010, a display chip 1020, a display chip 1030, and a display chip 1040.

In a CMYK 8-bit format, each pixel of the CMYK image is represented by 32 bits (that is, 4 bytes), and each color channel is represented by 8 bits (that is, 1 byte). The lower-level display chip may extract required data of a color channel, for example, any one or more of C-channel data, M-channel data, Y-channel data, and K-channel data, based on a specific bit. In this embodiment of this application, a process of extracting the color channel data from the CMYK image is similar to the process of extracting the color channel from the RGB image. For details, refer to the descriptions in FIG. 5 to FIG. 9. Details are not described again in this application.

The image display method provided in this application is applicable to displaying an image including a plurality of color channels. In addition to the RGB image and the CMYK image in the foregoing embodiments, a Lab image may be further displayed. The Lab image includes a lightness channel, a red-green degree (a-axis) channel, and a yellow-blue degree (b-axis) channel. A specific displayed image should not be understood as a limitation on this application. An application scenario of the image display method provided in this application includes but is not limited to AR, virtual reality (VR), hybrid reality (MR), and conventional display device display.

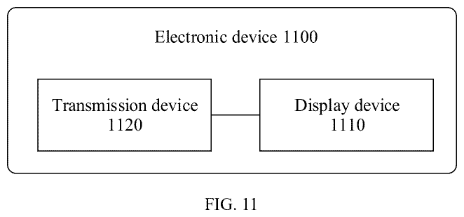

The foregoing describes the image display method and the display device according to embodiments of this application. The following describes an electronic device 1100 according to an embodiment of this application with reference to FIG. 11.

The electronic device 1100 includes a transmission component 1120 and a display device 1110. The transmission component 1120 is configured to transmit data of a to-be-displayed image to the display device 1110. The display device 1110 may be the display device 300 shown in FIG. 3, or may be the display device shown in FIG. 6 or FIG. 10.

A structure of the electronic device 1100 shown in FIG. 11 is merely an example for description, and this application is not limited thereto. A person skilled in the art should understand that the electronic device 1100 may further include another component required for implementing normal running. In addition, based on a specific requirement, a person skilled in the art should understand that the electronic device 1100 may further include a hardware component for implementing another additional function.

It should be understood that sequence numbers of the foregoing processes do not mean execution sequences in various embodiments of this application. The execution sequences of the processes should be determined based on functions and internal logical of the processes, and should not be construed as any limitation on the implementation processes of embodiments of this application.

A person of ordinary skill in the art may be aware that, the devices and method steps in the examples described with reference to embodiments disclosed in this specification may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing electronic device and display device, refer to a corresponding process in the foregoing method embodiments. Details are not described herein again.

In the several embodiments provided in this application, it should be understood that the disclosed devices and methods may be implemented in other manners. For example, the foregoing described apparatus embodiments are merely examples. For example, division into the units is merely logical function division, and there may be another division manner during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in an electronic form, a mechanical form, or another form.

The units described as separate parts may or may not be physically separate, and parts displayed as units may or may not be physical units, and may be located in one position, or may be distributed on a plurality of network units. A part or all of the units may be selected based on actual requirements to achieve the objectives of the solutions of embodiments.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A display device, comprising an application processor and a display circuit connected to the application processor, wherein the display circuit comprises N display chips, each of the N display chips comprises a receive interface and an extraction circuit, the receive interfaces of the N display chips are respectively connected to a transmit interface of the application processor, and N is an integer greater than or equal to 2;
the application processor is configured to send a to-be-displayed image to each of the N display chips, wherein the to-be-displayed image comprises data of M color channels, and M is an integer greater than or equal to 2; and
each of the N display chips is configured to extract, via the extraction circuit, data of P target color channels from the to-be-displayed image for display, wherein P is an integer, and 1≤P<M.

2. The display device according to claim 1, wherein each of the N receive interfaces of the N display chips comprises a terminal resistor, and the terminal resistors of the N receive interfaces are connected in parallel.

3. The display device according to claim 2, wherein at least a part of the N receive interfaces share a terminal resistor.

4. The display device according to claim 2, wherein the terminal resistor of the receive interface is Q times a terminal resistor of the transmit interface, and 1<Q≤N+1.

5. The display device according to claim 1, wherein the receive interface is configured to:
receive the to-be-displayed image, and send the to-be-displayed image to the extraction circuit.

6. The display device according to claim 1, wherein each of the N display chips further comprises a display, and the display is configured to display the data of the P target color channels.

7. The display device according to claim 1, wherein the transmit interface and the receive interface are high-speed serial interfaces.

8. The display device according to claim 1, wherein the to-be-displayed image comprises a red green blue (RGB) image, and the data of the M color channels comprises red (R)-channel data, green (G)-channel data, and blue (B)-channel data.

9. An image display method, applied to a display device, wherein the display device comprises an application processor and a display circuit connected to the application processor, the display circuit comprises N display chips, each of the N display chips comprises a receive interface and an extraction circuit, the receive interfaces of the N display chips are respectively connected to a transmit interface of the application processor, and N is an integer greater than or equal to 2; and the method comprises:
sending, by the application processor, a to-be-displayed image to each of the N display chips, wherein the to-be-displayed image comprises data of M color channels, and M is an integer greater than or equal to 2; and
receiving, by each of the N display chips, the to-be-displayed image, and extracting, via the extraction circuit, data of P target color channels from the to-be-displayed image for display, wherein P is an integer, and 1≤P<M.

10. The method according to claim 9, wherein each of the N receive interfaces of the N display chips comprises a terminal resistor, and the terminal resistors of the N receive interfaces are connected in parallel.

11. The method according to claim 10, wherein at least a part of the N receive interfaces share a terminal resistor.

12. The method according to claim 10, wherein the terminal resistor of the receive interface is Q times a terminal resistor of the transmit interface, and 1<Q≤N+1.

13. The method according to claim 9, wherein each of the N display chips further comprises a display; and
receiving, by each of the N display chips, the to-be-displayed image, and extracting, via the extraction circuit, the data of the P target color channels from the to-be-displayed image for display comprises:
receiving, by the receive interface, the to-be-displayed image, and sending the to-be-displayed image to the extraction circuit;
extracting, by the extraction circuit, the data of the P target color channels from the to-be-displayed image; and
displaying, by the display, the data of the P target color channels.

14. The method according to claim 9, wherein the transmit interface and the receive interface are high-speed serial interfaces.

15. The method according to claim 9, wherein the to-be-displayed image comprises a red green blue (RGB) image, and the data of the M color channels comprises red (R)-channel data, green (G)-channel data, and blue (B)-channel data.

16. An electronic device, comprising a transmission component and a display device, wherein the display device comprises an application processor and a display circuit connected to the application processor, wherein the display circuit comprises N display chips, each of the N display chips comprises a receive interface and an extraction circuit, the receive interfaces of the N display chips are respectively connected to a transmit interface of the application processor, and N is an integer greater than or equal to 2;
the application processor is configured to send a to-be-displayed image to each of the N display chips, wherein the to-be-displayed image comprises data of M color channels, and M is an integer greater than or equal to 2; and
each of the N display chips is configured to extract, via the extraction circuit, data of P target color channels from the to-be-displayed image for display, wherein P is an integer, and 1≤P<M, wherein the transmission component is configured to transmit data of the to-be-displayed image to the display device.

17. The electronic device according to claim 16, wherein each of the N receive interfaces of the N display chips comprises a terminal resistor, and the terminal resistors of the N receive interfaces are connected in parallel.

18. The electronic device according to claim 17, wherein at least a part of the N receive interfaces share a terminal resistor.

19. The electronic device according to claim 17, wherein the terminal resistor of the receive interface is Q times a terminal resistor of the transmit interface, and 1<Q≤N+1.

20. The electronic device according to claim 16, wherein the receive interface is configured to: receive the to-be-displayed image, and send the to-be-displayed image to the extraction circuit.
